(19) United States
(12) Patent Application Publication
(10) Pub. No.: US 2015/0019641 A1
(43) Pub. Date: Jan. 15, 2015

(54) Automatically Creating Companionship Based on Selectable Objects in a Social Environment

(71) Applicant: Sameer Nandan Nayak, Austin, TX (US)

(72) Inventor: Sameer Nandan Nayak, Austin, TX (US)

(21) Appl. No.: 14/325,698

(22) Filed: Jul. 8, 2014

Related U.S. Application Data
(60) Provisional application No. 61/844,613, filed on Jul. 10, 2013.

(51) Int. Cl. H04L 12/58; G06Q 50/00

(52) U.S. Cl. CPC H04L 51/32; G06Q 50/01
USPC 709/204

(57) ABSTRACT

The embodiments herein provide a method and system for automatically creating a companionship between a user and at least one item source using a server. The method includes rendering a virtual environment selected by a user, wherein the virtual environment is configured to simulate a virtual appearance of a real-world entity. Further, the method includes receiving at least one item selected by the user from a plurality of items, wherein the at least one item is associated with at least one item source. Further, the method includes displaying the selected items in the virtual environment, wherein the selected items is integrated in the virtual environment. Furthermore, the method includes automatically creating a companionship between the user and the at least one item source based on the selected items.

### PRIORTY CLAIM

The present application is based on, and claims priority from, U.S. Application No. 61/844,613, filed on Jul. 10, 2013, the disclosure of which is hereby Incorporated by reference herein.

### TECHNICAL FIELD

The present invention relates to social networking environment, more particularly, to a system and method for automatically establishing a friend connection based on selectable items on a server.

### BACKGROUND

Generally, most of the users start product discovery and purchase process by viewing product information from various service providers. The various service providers described herein can include for example, but not limited to, merchant & manufacturer websites, producers, farmers, publications, product catalogues, product related blogs, reviews, customer experience, customer support centers, product documentations, social networking portals, and the like. The service providers are able to access and share various contents (such as for example, but not limited to, products, produce, services, objects, items, personal information, contacts, images, albums, maps, and the like) through various local and wide area computer networks. Such content is often suitable for supply chain management, computer aided design software, computer aided drawing tools, personalized calendars, greeting cards, photo albums, books, promotional materials, and the like.

Conventional approaches to enable sharing of the generated content include various information sharing technologies or platforms such as social networking platforms file sharing on servers, and the like. Searching such contents on Internet and interacting with the service providers involves significant challenges. Conventional mechanisms allow the user to search interested content(s) and interact with the service provider via phone, email, SMS, and the like. In another mechanism, the user can use a social networking platform to interact with the service providers. Making companionship (or establishing a friend connection) among the users and service providers on such platform is a tedious process. Many different methods and systems are proposed to establish a connection between the users in the social networking environment. Existing system and methods allows the user to search for a service provider and send a request to get connected. The user needs to wait till the service provider accepts the connection request. This delay in response from the service provider or user may waste a significant amount of time that can be used for communication & collaboration productivity.

Therefore, there remains a need of a dynamic, robust, and simple collaborative platform for instantly connecting users and services providers, such as to enable effective communications among each other.

### SUMMARY

The embodiments herein provide a method for automatically creating a companionship between a user and at least one item source using a server. The method includes rendering a virtual environment selected by a user, wherein the virtual environment is configured to simulate a virtual appearance of a real-world entity. Further, the method includes receiving at least one item selected by the user from a plurality of items, wherein the at least one item is associated with at least one item source. Further, the method includes displaying the selected items in the virtual environment, wherein the selected items is integrated in the virtual environment. Furthermore, the method includes automatically creating a companionship between the user and the at least one item source based on the selected items.

The embodiments herein provide a server for automatically creating a companionship between a user and at least one item source. The server is configured to render a virtual environment selected by a user, wherein the virtual environment is configured to simulate a virtual appearance of a real-world entity. Further, the server is configured to receive at least one item selected by the user from a plurality of items, wherein the at least one item is associated with at least one item source. Further, server is configured to display the selected items in the virtual environment, wherein the selected items are integrated in the virtual environment. Furthermore, the server is configured to automatically create a companionship between the user and the at least one item source based on the selected items.

The embodiments herein provide a computer program product including a computer executable program code recorded on a computer readable non-transitory storage medium. The computer executable program code when executed causing the actions including rendering a virtual environment selected by a user, wherein the virtual environment is configured to simulate a virtual appearance of a real-world entity. Further, the computer executable program code when executed causing the actions including receiving at least one item selected by the user from a plurality of items, wherein the at least one item is associated with at least one item source. Further, the computer executable program code when executed causing the actions including displaying the selected items in the virtual environment, wherein the selected items is integrated in the virtual environment. Furthermore, the computer executable program code when executed causing the actions including automatically creating a companionship between the user and the at least one item source based on the selected items.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE FIGURES

The embodiments herein will be better understood from the following detailed description with reference to the drawings, in which:

FIG. 1 is a block diagram illustrates generally, among other things, a high level architecture of a system, according to embodiments described herein;

FIG. 2 is a sequence diagram illustrates generally, operations performed by the system as described in the FIG. 1, according to embodiments described herein;

FIG. 3 shows an exemplary illustration of virtual environment, according to embodiments described herein;

FIG. 4 shows an exemplary illustration of items displayed to customer, according to embodiments described herein;

FIG. 5 shows an exemplary illustration of the items moved to the virtual environment, according to embodiments described herein;

FIG. 6 shows an exemplary illustration of companionship created by server, according to embodiments described herein;

FIG. 7 illustrates a flow chart illustrating a method for automatically creating a companionship based on selectable items on the server, according to embodiments disclosed herein;

FIG. 8 illustrates an example scenario where the server simulates virtual presentation of a car and automatically creates a companionship between the user and the items sources based on the select items, according to embodiments described herein; and

FIG. 9 illustrates an example scenario where the server simulates virtual presentation of an interior of home and automatically creates a companionship between the user and the items sources based on the select items, according to embodiments described herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a system and method for automatically creating a companionship based on selectable items on a server. In an embodiment, the server is configured to receive one or more items information associated with a plurality of item sources. The plurality of item sources described herein can include for example, but not limited to, merchant, manufacturer, third-party website, official website, social portal, and the like. Unlike conventional systems, the server can be configured to collaborate/integrate the items information received from the plurality of item sources to provide a unified/collaborated platform. The server is configured to allow a user to select a virtual environment hosted by the server. In an embodiment, the virtual environment described herein can be configured to simulate a virtual appearance of a real-world entity as desired by the user. The virtual environment can be for example, but not limited to, a drawing canvas, a drawing editor, or any other virtual area provided to the user, such as to visualize virtually the real-world entities or real items. The server can be configured to allow the user to select and move one or more items associated with the item sources into the virtual environment. Further, the server is configured to automatically create companionship between the user and item sources associated with the items selected by the user. Unlike conventional system, the server is configured to automatically establish a friend connection between the user and the item sources, without any user or item source interference. The friend connection between the user and the item sources is created instantly such that the user can communicate with the item sources, such as to enquire or receive any information about the selected items.

The proposed invention is simple, reliable, dynamic, and robust for automatically establishing a friend connection between the user and plurality of item sources, such as to provide a unified/collaborated platform to instantly communicate among each other. Unlike conventional systems, the present invention provides the unified/collaborated system and method by integrating all the item information received from various item sources. Such unified/collaborated systems can be used to provide the merchants and manufactures a common platform to make the supply and demand chain management simple and efficient. The system can be used to provide a collaborated source following a common format for all the items throughout the system, such as to significantly decrease the customer time for searching the item(s) thereby increasing the overall customer experience. Further, the system and method can be configured to allow the user to instantly communicate with service provides by automatically creating a companionship (or establish a friend connection) between the user and the item sources. Unlike conventional systems, instead of wasting time in calling, emailing, or messaging service providers, or in waiting for the service provider to accept the friend request, the user can use the proposed system and method to instantly connect and communicate with the service providers. Furthermore, the service providers use the unified platform to commercialize their items and instantly communicate with their leads of interest. Furthermore, the system and method can be used to enhance the supply change management activities and increases the throughput at a reasonable system cost. Furthermore, the proposed system and method can be implemented on the existing infrastructure and may not require extensive set-up or instrumentation.

Throughout the description the term customer and user is used interchangeably.

Throughout the description the term product and item is used interchangeably.

Throughout the description the “service provider” and “item source” is used interchangeably.

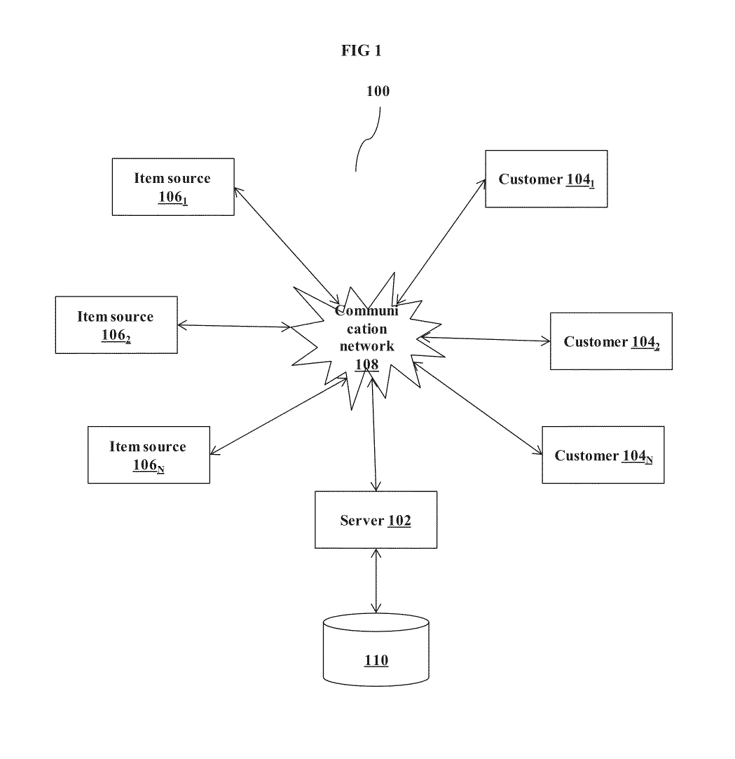

Referring now to the drawings, and more particularly to FIGS. 1 through 9, where similar reference characters denote corresponding features consistently throughout the figures, there are shown embodiments.

FIG. 1 is a block diagram illustrates generally, among other things, a high level architecture of a system 100, according to embodiments described herein. The system 100 includes a server 102 (central or distributed device) communicating, one or more customer 104 (hereafter referred as customer(s) 104), and a plurality of item sources 106 (hereafter referred as item source(s) 106) communicating among each other over a communication network 108.

In an embodiment, the customer 104 described herein can include any user controlling or managing an electronic device such as for example, but not limited to, personal computer, personal digital assistance (PDA), mobile device, smart phone, desktop computer, laptop, tablet, consumer electronic devices, or the like. In an embodiment, the item sources 106 described herein can include for example, but not limited to, manufacturer, producer, merchant, third-party websites, recommendations systems, and the like. In an embodiment, the communication network 108 described herein can include for example, but not limited to, wireless network, wire line network, global system for mobile communication, cellular network, local area network, wide area network, metropolitan area network, a combination thereof, or any other network.

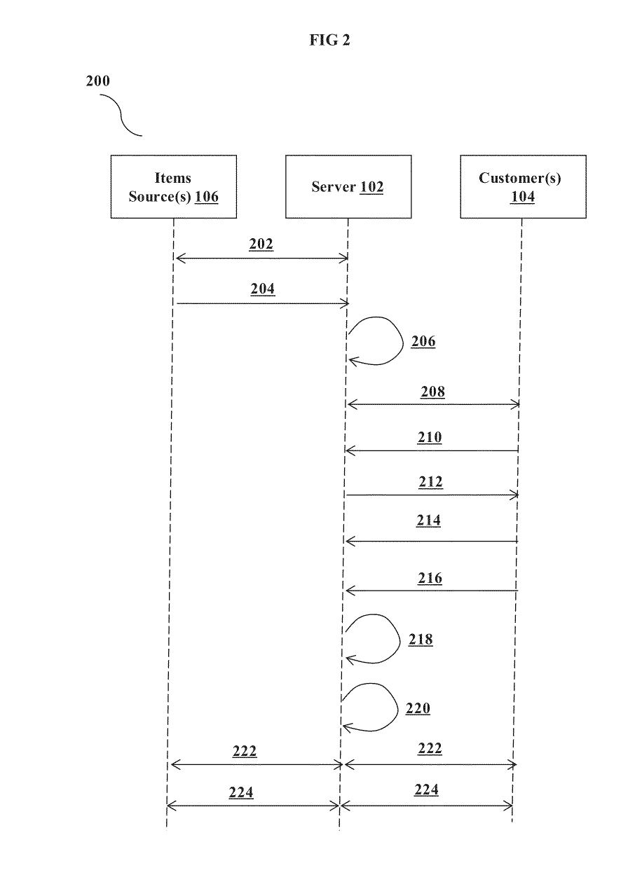

In an embodiment, the server 102 described herein can be an engine or any general purpose computer capable of managing and controlling data over the communication network 108. The server 102 can be configured to include various interfaces to communicate with various internal and external components of the system 100. The server 102 can be configured to include or coupled to a data store 110. The data store 110 can be configured to store various items information received from the information sources 106. The various items information received from the information sources 106 can be collaborated to provide a unified decision-making process to the customer 104. The system 100 allows the customers 104 and the item sources 106 to log into the server 102 and perform various operations during a supply chain management process. The various operations performed by the system 100 are described in conjunction with the FIG. 2.

Though the FIG. 1 shows one server 102, three customers 104, and three item sources 106 communicating among each other but, it is to be understood that another embodiment is not limited thereto. Further, the system 100 can include any number of servers, customers, and item sources, along with other hardware or software components such as rendering engine, companionship making agent, controller, and the like communicating among each other over the communication network. For example, the component can be, but not limited to, a process running in the controller/processor, an object, an executable process, a thread of execution, a program, and/or a computer. By way of illustration, both an application running on a controller and the controller can be the component.

FIG. 2 is a sequence diagram 200 illustrates generally, operations performed by the system 100 as described in the FIG. 1, according to embodiments described herein. In an embodiment, at 202, the server 102 can be configured to allow the item source 106 to register and log into the server 102. The system 100 allows the item source 106 to register and log into the server 102 through the using conventional registration process and perform various operations during the supply chain management process. The server 102 can be configured to store the item source preferences and credentials into the data store 110. The item source 106 can log into the server 102 using customer credentials such as for example, but not limited to, source ID, emails, password, and the like.

In an embodiment, at 204, the server 102 can be configured to receive item(s) information from various item sources 106. The item information described herein can include for example, but not limited to, item image, item video, item drawing, item design, item specification, and the like. In an embodiment, the items can be related to any online content. The item sources 106 can upload the items into the server 102. In an embodiment, the server 102 can be configured to create item library for each source such that each item source can access and update the items library at any given time.

In an embodiment, at 206, the server 102 can be configured to integrate the items information received from the item sources 106. Unlike conventional systems, the server 102 can be configured to provide a unified/collaborated platform by integrating all the items received from the various information sources 106. The collaborated information can be used to allow the customer to easily discover the items of interest. The item sources 106 use the unified platform to commercialize their items and instantly communicate with their leads of interest. Further, such unified platform can be used to make the supply chain management simple and efficient.

In an embodiment, at 208, the server 102 can be configured to allow the customers 104 to register and/or log into the server 102. The system 100 allows the customers 104 to register and log into the server 102 using the conventional registration techniques. The server 102 can be configured to store the customer preferences into the data store 110. The customer 104 can log into the server 102 using customer credentials such as for example, customer ID, emails, password, and the like.

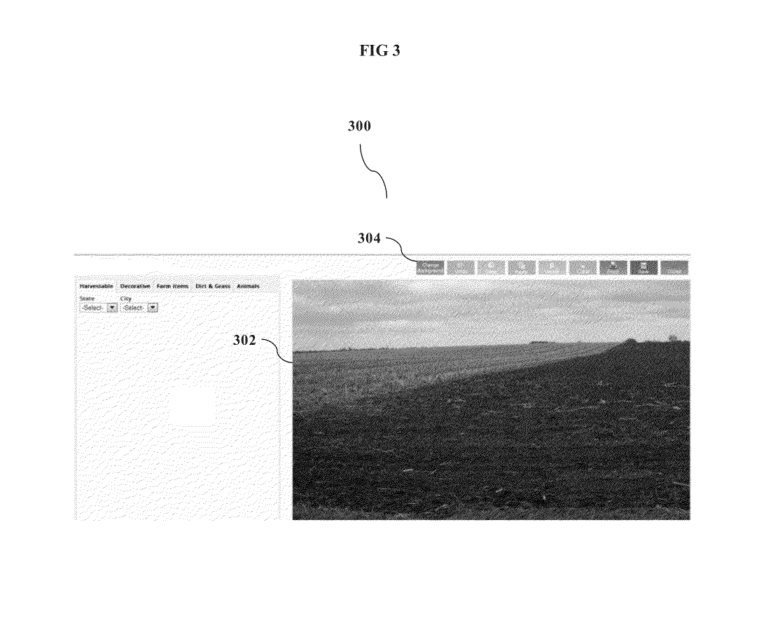

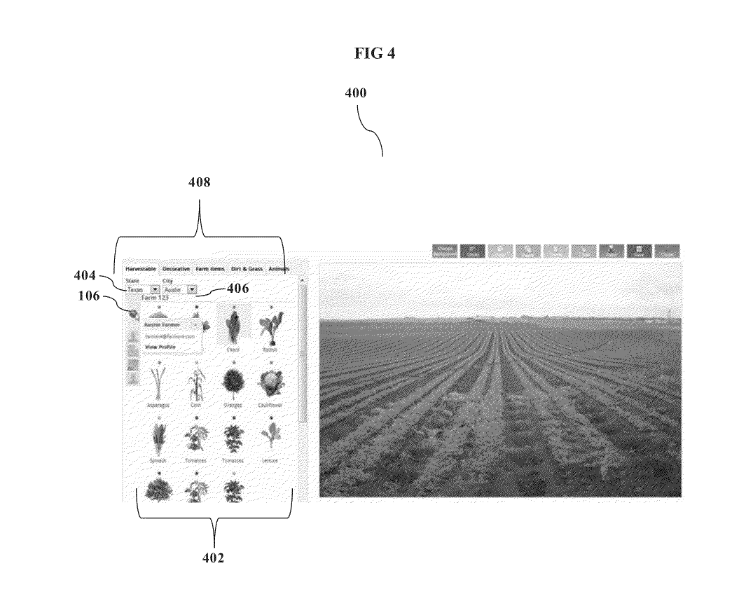

In an embodiment, at 210, the server 102 can be configured to allow the customer 104 to select a virtual environment hosted by the server 102. In an embodiment, the virtual environment described herein can be configured to simulate a virtual appearance of a real-world entity as desired by the user., The virtual environment can be for example, but not limited to, a drawing canvas, a drawing editor, or any other virtual area provided to the user, such as to visualize virtually the real-world entities or real items. For example, if the user is interested in purchasing a real-world entity like a car, a virtual skeleton or chassis of the car can be simulated to the user for designing the car using various parts of the user choice. In an embodiment, the server 102 can be configured to create the virtual environment selected by the customer 104. An exemplary illustration of the virtual environment is described in conjunction with the FIG. 3. In an embodiment, at 212, the server 102 can be configured to display a plurality of items associated with the item sources 106. The server 102 can be configured to allow the customer 104 to customize the display of items according to the customer preferences such as location, interested items, interested service provider, and the like. An exemplary illustration of the items displayed to the customer is described in conjunction with the FIG. 4.

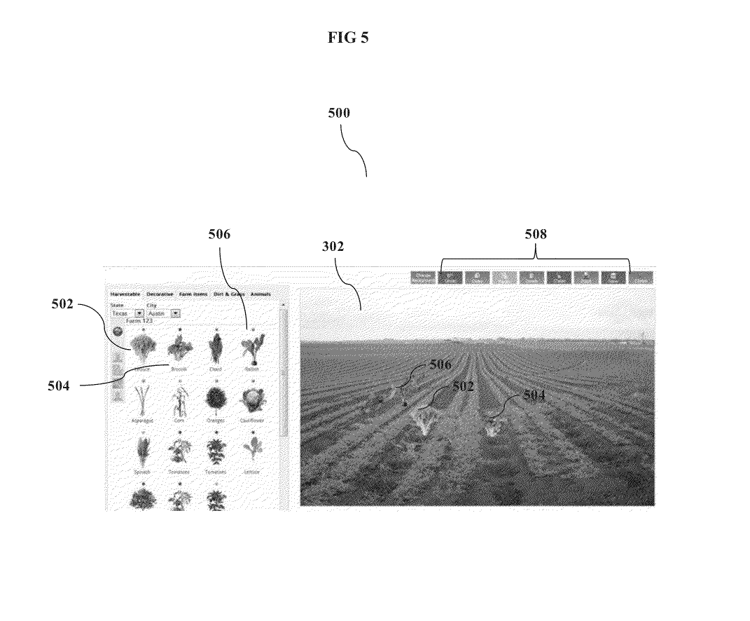

In an embodiment, at 214, the server 102 can be configured to allow the customer 104 to select one or more items associated with the item sources 106. In an embodiment, at 216, the server 102 can be configured to allow the customer 104 to move the selected item into the virtual environment. The customer 104 can select the interested items from the list of items displayed and move into the virtual environment. In an embodiment, the customer 104 can select and move the items by using a drag-and-drop method. In an embodiment, the customer 104 can select the items and press on a button to move the item into the virtual environment. In an embodiment, the customer can perform gestures, or use any other input means to select and move the items into the virtual environment. Further, an exemplary illustration of the items moved to the virtual environment is described in conjunction with the FIG. 5.

In an embodiment, at 218, the server 102 can be configured to store the virtual environment along with the items of interest. When the customer 104 completes the process of selecting and moving interested items into the virtual environment, the server 102 can be configured to store the virtual environment along with the items of interest. In an embodiment, at 220, the server 102 can be configured to automatically create a companionship between the customer 104 and the item sources 106 associated with the items selected by the customer 104. The companionship described here can be a 2-way companionship, where both the parties provide sufficient rights to the server 102 in order to establish a dynamic friend connection between them such that both the parties can be instantly connect and interact with each other. As the server 102 includes information about the customer 104 and the item sources 106, the server 102 can be configured to establish a friend connection by mapping the customer 104 data with the data associated with item sources 106. In an embodiment, the server 102 can be configured to communicate with one or more social network servers or sites such as to dynamically establish the connection between the user and the item sources. For example, the server 102 may integrate with an Elgg PHP social networking framework or any other social networking sources to dynamically establish the companionship. The server 102 may initiate an AJAX call to the Elgg server, such as to dynamically establish the friend connection between the customer 104 and the item source 106. Further, the server 102 can be configured to add the respective item sources 106 into customer friends list and the respective customer 104 into the item source friends list.

In an embodiment, at 222, the server 102 can be configured to allow the customer 104 to instantly communicate with the item sources 106. The server 102 can be configured to facilitate a real-time communication session between the user and the item sources based on the companionship, wherein the real-time communication can include an online chat. In another embodiment, the server 102 can be configured to facilitate a non-real-time communication session between the user and the item sources based on the companionship, wherein the real-time communication can include an offline chat or emails. Unlike conventional systems, instead of wasting time in calling, emailing, or messaging the service provider, or in waiting for the service provider to accept the friend request, the customer 104 can use the proposed system 100 to instantly connect and communicate with the service providers.

In an embodiment, at 222, the server 102 can be configured to perform one or more actions based on the communication performed with the item sources. The actions described herein can include for example, but not limited to, performing a transaction to purchase one or more items from the item sources, performing a purchase transaction to sponsor the items to the user, enquiring about the product, and the like. Further, the customer can showcase or share the car with the selected items with friends and family members. Unlike conventional systems, the virtual environment along with the items can be shared with one or more friends and family members of the user such that they can sponsor one or more items for the user.

The various operations, acts, or steps described with respect to the FIG. 2 can be performed in the order present, simultaneously, parallel, combination thereof, or in any order. The operations, acts, or steps herein are only for illustrative purpose and do not limit the scope of the invention. Further, in some embodiments some of the operations, acts, or steps can be added, skipped, omitted, or modified without departing from the scope of the invention.

FIG. 3 shows an exemplary illustration 300 of a virtual environment 302, according to embodiments described herein. In an embodiment, the server 102 can be configured to allow the customer 104 to select a virtual environment. In an embodiment, the virtual environment described here can be for example, but not limited to, a drawing canvas, drawing editor, or any other virtual area simulating virtual appears of real-world entities selected by the user. An exemplary illustration of a farmer field is described in the FIG. 3. The server 102 allows the customer 104 to select the virtual environment 302. The server 102 can be configured to allow the customer to customize the virtual environment 302 according to their needs and requirements. For example, the user can change the background of the virtual environment 302 using a change background option 304. The virtual environment 302 can be used to enable a virtually real environment for the customer 104 to visualize the items selected by the customer 104. For example, the virtual environment 302 provides the customer 104 virtually real feelings as if the customer 104 is actually harvesting the field.

FIG. 4 shows an exemplary illustration 400 of items 402 displayed to the customer 104, according to embodiments described herein. In an embodiment, the server 102 can be configured to display the plurality of items associated with the item sources 106. For example, as shown in the FIG. 4, the server 102 display the items 402 associated with the plurality of item sources 106. The item 402 can be displayed to the customer 104 in a way that appears to the customer 104 as if the customer 104 is viewing the real items. For example, the items 402 shown in the FIG. 4 are the real images of the items. In an embodiment, the server 102 can be configured to allow the customer 104 to customize the display of the items 402 according to the customer preferences such as location, interested items, interested service provider, and the like. For example, the customer 104 can use the options 404 and 406 to change the location. When customer 104 can uses the option 404 to select the state and the option 406 to select the city, an Ajax call to server 102 can be initiated along with the selected state and city information such as to locate the item sources 106 in that area. In an embodiment, the server 102 can be configured to provide other different options 402 such as for example, but not limited to, “Decorative”, “Animals”, “Dirt & Grass”, “Farm Items” and the like, such as to locate the items and item sources according to their needs and requirements.

FIG. 5 shows an exemplary illustration 500 of the items 402 moved to the virtual environment 302, according to embodiments described herein. In an embodiment, the server 102 can be configured to allow the customer 104 to select and move the one or more items associated with the item sources 106 into the virtual environment. For example, as shown in the FIG. 5, the customer 104 can select the item 502 and move it into the virtual environment 302. A replicated image of the item 502 is moved into the virtual environment 302. Similarly, the customer can select the item 504 and move it into the virtual environment 302. Similarly, the customer can select the item 506 and move it into the virtual environment 302. In an embodiment, the server 102 allows the customer to select one item at a time and move it into the virtual environment 302. For example, the customer 104 can select an item by clicking or tapping on it and drag-and-drop the item into the virtual environment 302. In an embodiment, the server 102 allows the customer to select more than one item at a time and move them into the virtual environment 302. For example, the customer can select two or more items and drags-and- drops or presses a button to push the selected items into the virtual environment 302. Further, the customer 104 can move the items into the virtual environment 302 using any other input means such as for example, but not limited to, gestures, gazing, mouse, pointer, touch, or the like. In an embodiment, when the customer 104 moves the selected items into the virtual environment 302, the server 102 collects metadata information associated with each item moved into the virtual environment 302. In an embodiment, the metadata information described herein can include for example, but not limited to, item name, item reference, item source information, image scale, rotation angle, and the like. In an embodiment, the server 102 can provide different options 508 such as for example, but not limited to, “delete”, “copy”, “paste”, “clear”, “print”, “save” “close”, and the like, to perform various operations on the virtual environment 302. For example, if the customer 104 clicks on the clear option then the server 102 can be configured to clear the all the items moved into the virtual environment 302. In another example, if the customer 104 clicks on the save option then the server 102 can be configured to store the virtual environment along with the selected items into the database 110. In yet another example, if the user clicks on the print option then the server 102 can be configured to signal a printer to print the virtual environment 302.

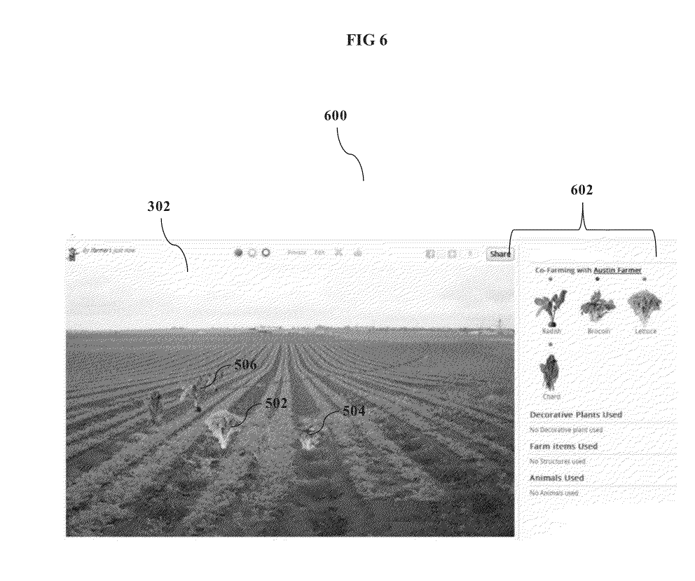

FIG. 6 shows an exemplary illustration 600 of companionship created by the server 102, according to embodiments described herein. In an embodiment, when the customer 104 completes the process of selecting and moving interested items into the virtual environment 302, the server 102 can be configured to dynamically create a companionship between the customer 104 and the item sources 106 associated with the items moved by the customer 104. As the server 102 includes information about the customer 104 and the item sources 106, the server 102 can be configured to establish a friend connection by mapping the customer 104 data with the data associated with the item sources 106. In an embodiment, the server 102 can be configured to communicate with one or more social network servers or sites such as to dynamically establish the connection between the customer 104 and the item sources 106. For example, the server 102 may integrate with an Elgg PHP social networking framework or any other social networking sources to dynamically establish the companionship. The server 102 may initiate an AJAX call to the Elgg server, such as to dynamically establish the friend connection between the customer 104 and the item source 106. The Elgg server may receives the all the metadata information about associated with the items selected by the customer 104. The metadata information can be verified and the server 102, in communicated with the Elgg server, can be configured to add the respective item sources 106 into the customer friends list and the customer 104 into the item source friends list. An exemplary illustration of item sources added into the customer friends list is shown at 602 of the FIG. 6. For example, if the items 502, 504, and 506 are associated with an item source for example “Austin farmer” then the server 102 automatically creates a friend connection with “Austin farmer” and adds ‘Austin farmer” into friends list of the customer 104, such as shown at 602. Further, the server 102 can be configured to allow the customer 104 to instantly communicate with the item source 106. Unlike conventional systems, instead of wasting time in calling, emailing, or messaging the service provider, or in waiting for the service provider to accept the friend request, the customer 104 can now instantly connect and communicate with the service providers.

The options, labels, names, service providers, images, user interfaces, and the like elements or components used with respect to the FIGS. 3 through 6 are only for illustrative purpose and does not limit the scope of the invention. Further, in real-time, any type of labels, components, user interfaces, elements, and the like, can be used to perform the various operations disclosed herein without departing from the scope of the invention.

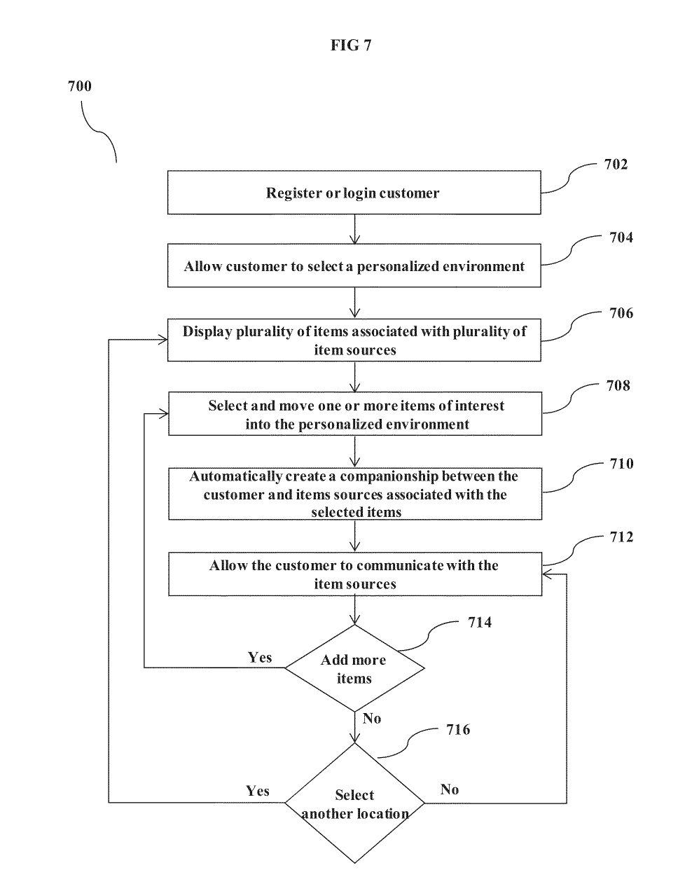

FIG. 7 illustrates a flow chart illustrating a method 700 for automatically creating a companionship based on selectable items in a server, according to embodiments disclosed herein. The various steps of the method 700 are summarized into individual blocks where some of the steps are performed by the server 102, the customer 104, the item sources 106, and the like. The method 700 and other description specified herein can be easily implemented by a microcontroller, microprocessor, or an equivalent thereof.

In an embodiment, at step 702, the method 700 includes registering or logging the customer 104 into the server 102. In example, the method 700 allows the customer 104 to register and log into the server 102 using the conventional registration techniques. The method 700 allows the server 102 to store the customer preferences into the data store 110. The customer 104 can log into the server 102 using customer credentials such as for example, customer ID, emails, password, and the like.

In an embodiment, at step 704, the method 700 includes allowing the customer 104 to select a virtual environment hosted by the server 102. The virtual environment described here can be a drawing canvas, drawing editor or any other virtual area provided to the user, such as to visualize the virtually real items. In an example, the method 700 allows the server 102 can be configured to create the virtual environment selected by the customer 104.

In an embodiment, at step 706, the method 700 includes displaying a plurality of items associated with the item sources 106. In an example, the method 700 allows the server 102 to the item source 106 to register and log into the server 102 through the using conventional registration process and perform various operations during the supply chain management process. The method 700 allows the server 102 can to store the item source preferences and credentials into the data store 110. The item source 106 can log into the server 102 using customer credentials such as for example, but not limited to, source ID, emails, password, and the like. In an embodiment, the method 700 includes receiving item(s) information from various item sources 106. The item information described herein can include for example, but not limited to, item image, item video, item drawing, item design, item specification, and the like. In an embodiment, the items can be related to any online content. The method 700 allows the item sources 106 to upload the items into the server 102. The method allows the server 102 to create an item library for each source such that each item source can access and update the items library at any given time. Further, the method 700 allows the server to integrate the items information received from the item sources 106. Unlike conventional systems, the method 700 allows the server 102 to provide a unified/collaborated platform by integrating all the items received from the various information sources 106. The method 700 allows the server 102 to display the collaborated items to the customer 104, such as to allow the customer 104 to easily discover the items of interest. In an embodiment, the server can be configured to allow. Furthermore, the method 700 allows the customer 104 to customize the display of items according to the customer preferences such as location, interested items, interested service provider, and the like.

In an embodiment, at step 708, the method 700 includes selecting and moving one or more items associated with the item sources 106 into the virtual environment. In an embodiment, the method 700 allows the customer 104 to select the interested items from the collaborated list of items (displayed by the server 102) and move into the virtual environment. In an example, the method 700 allows the customer 104 to select and move the items by using a drag-and-drop method. In an example, the method 700 allows the customer 104 to select the items and press on a button to move the item into the virtual environment. In an embodiment, the method 700 allows the customer 104 to perform gestures, or use any other input means to select and move the items into the virtual environment. When the customer 104 completes selecting and moving interested items into the virtual environment, the method 700 allows the server 102 to store the virtual environment along with the items of interest into the database 110.

In an embodiment, at step 710, the method 700 includes automatically creating a companionship between the customer 104 and the item sources 106 associated with the items selected by the customer 104. The companionship described here can be a 2-way companionship, where both the parties provide sufficient rights to the server 102 in order to establish a dynamic friend connection between them such that both the parties can be instantly connect and interact with each other. As the server 102 includes information about the customer 104 and the item sources 106, the method 700 allows the server 102 to establish a friend connection by mapping the customer 104 data with the data associated with the item sources 106. In an embodiment, the method 700 allows the server 102 to communicate with one or more social network servers or sites, such as to dynamically establish the connection between the user and the item sources. For example, the method 700 allows the server 102 to integrate with an Elgg PHP social networking framework or any other social networking sources to dynamically establish the companionship. The method 700 allows the server 102 to initiate an AJAX call to the Elgg server, such as to dynamically establish the friend connection between the customer 104 and the item source 106. Further, the method 700 allows the server 102 to add the respective item sources 106 into customer friend list and the customer 104 to item sources friend lists.

In an embodiment, at step 712, the method 700 includes allowing the customer 104 to communicate with the item sources 106. The method 700 allows the server 102 to facilitate a real-time communication session between the user and the item sources based on the companionship, wherein the real-time communication can include an online chat such as instant messaging, video conferencing, text chat, voice chat, and the like. In another embodiment, the method 700 allows the server 102 to facilitate a non-real-time communication session between the user and the item sources based on the companionship, wherein the real-time communication can include an offline chat or emails. Unlike conventional systems, instead of wasting time in calling, emailing, or messaging the service provider, or in waiting for the service provider to accept the friend request, the customer 104 can the method 700 to instantly connect and communicate with the item source.

In an embodiment, the method 700 allows the server 102 to perform one or more actions based on the communication performed with the item sources. The actions described herein can include for example, but not limited to, performing a transaction to purchase one or more items from the item sources, performing a purchase transaction to sponsor the items to the user, enquiring about the product, and the like. Unlike conventional systems, the virtual environment along with the items can be shared with one or more friends and family members of the user such that they can sponsor one or more items for the user.

In an embodiment, at step 714, the method 700 includes determining whether more items needs to be added into the virtual environment. In an example, the method 700 allows the customer 104 to determine whether to add more items into the virtual environment. In an embodiment, if the customer 104 wanted to add more items into the virtual environment then the method includes repeating the steps 708 through 714. In an embodiment, at 716, the method 700 includes another location is selected by the customer 104. The method 700 allows the customer 104 to customize the display of items according to the customer preferences such as location, interested items, interested service provider, and the like. In an embodiment, in response to determining that the customer 104 changed the location the method 700 includes repeating the step 706 though 716. In an embodiment, in response to determining that the customer 104 does not changed the location the method 700 includes repeating the step 712 though 716.

The various actions, units, steps, blocks, and acts described in the method 700 may be performed in the order presented, in a different order, or simultaneously. Further, in some embodiments, some actions, units, steps, blocks, and acts listed in the FIG. 7 may be omitted, added, skipped, and modified without departing from the scope of the invention.

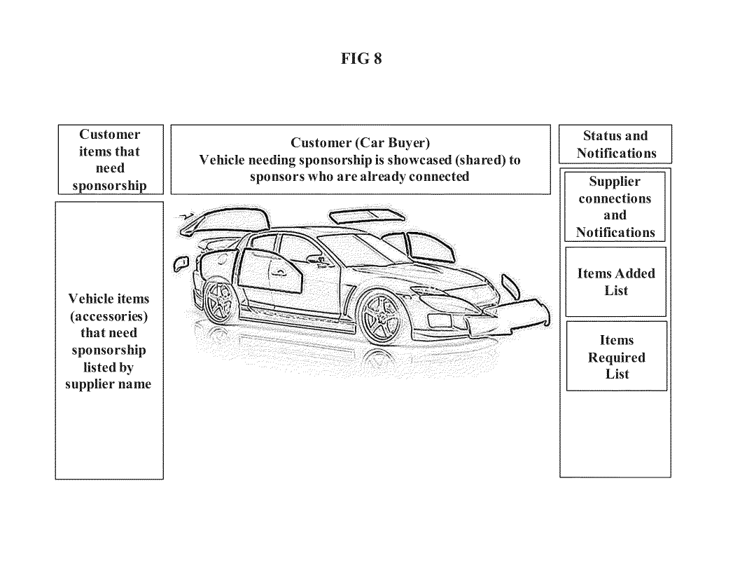

FIG. 8 illustrates an example scenario where the server simulates virtual presentation of a car and automatically creates a companionship between the customer and the items sources based on the select items, according to embodiments described herein. In an embodiment, the server 102 can be configured to simulate a virtual appears of the real-world entity like car selected by the user. For example, as shown in the FIG. 8, a virtual skeleton or chassis of the car can be displayed to the customer. The server 102 can be configured to allow the customer to customize the virtual environment according to their needs and requirements. The customer can design the car using interested items associated with different service providers. Such a car skeleton can be used to provide virtually real feelings to the customer to virtually feel how the car looks when the selected items are actually fixed on the car. Further, server 102 can be used to automatically establish a companionship among the customer and item sources associated with the items placed on the car skeleton. Unlike conventional systems, the proposed system and method can be used to provide a collaborative platform by creating automatic friend connection among the users, such as to provide a unified platform for communication among each other. Further, the customer can share the car with the selected items with friends and family members. For example, if the user select different items and showcases the virtually designed car for purchasing the items then the friends and family members can view and sponsor the user to buy the car. The friends and family members can use the server 102 to automatically create the companionship with the items sources. The friends and family members can purchase the items on behalf of the user or send the purchased items as a gift for the customer. As shown in the FIG. 8, the server 102 can be configured to provide timely notifications and manages the items sponsored list and yet to be sponsored list for the customer.

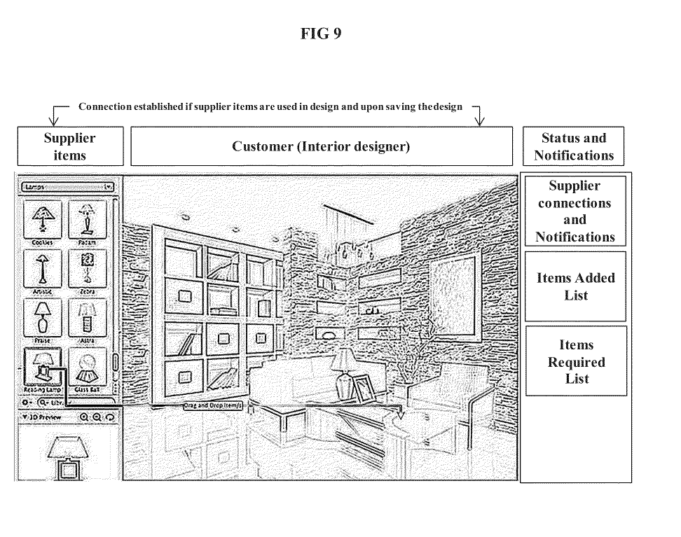

FIG. 9 illustrates an example scenario where the server simulates virtual presentation of an interior of home and automatically creates a companionship between the user and the items sources based on the select items, according to embodiments described herein. In an embodiment, the server 102 can be configured to simulate a virtual appears of the real-world entity like interior of home selected by the user. For example, as shown in the FIG. 8, a virtual representation of the user home can be displayed to the customer. The server 102 can be configured to allow the customer to customize the virtual environment according to their needs and requirements. The customer can decorate the home interior using interested items associated with different service providers. The virtual environment can be used to provide virtually real feelings to the customer to virtually feel how the home looks when the selected items are actually fixed at specific location in the home. Further, server 102 can be used to automatically establish a companionship among the customer and item sources associated with the items placed in the virtual environment representation interior of the customer home. Further, the customer can showcase the virtual environment representation interior of the customer home along with the selected items to the friends and family members. For example, if the user select different items and showcases the virtually decorated interior of the user home for purchasing the selected items then the friends and family members can view and sponsor the user to buy the items. The friends and family members can use the server 102 to automatically create the companionship with the items sources. The friends and family members can purchase the items on behalf of the user or send the purchased items as a gift for the customer. As shown in the FIG. 9, the server 102 can be configured to provide timely notifications and manages the items sponsored list and yet to be sponsored list for the customer.

Though the above description is described with respect to supply or demand chain management, where customer and service providers involved but, it is to be understood that another exemplary embodiment is not limited thereto. Further, the system and method can be used ecommerce or any other online business commercialization. For example, the system and method can be used for online shopping where a virtual environment such as an avatar is provided. The customer can dress up the avatar with different items associated with different service providers. Such an avatar can be used to provide virtually real feelings to the customer as if the customer is actually wearing the selected items. Further, the system and method can be used to automatically establish a companionship (a friend connection) among the customer and the items provided on the avatar. Furthermore, the avatar with the dressed items can be shared with the friends and family members who may sponsor one or more items. For example, the user can purchase the items on behalf of the user or send the purchased items as a gift for the user.

The embodiments disclosed herein can be implemented through at least one software program running on at least one hardware device and performing network management functions to control the network elements. The network elements shown in the FIGS. 1-9 include blocks which can be at least one of a hardware device, or a combination of hardware device and software module.

The embodiment disclosed herein specifies a system for automatically creating a companionship based on selectable items on a server. The mechanism allows the service providers to use a collaborated platform to commercialize their items and instantly communicate with their leads of interest by dynamically creating a friend connection, using the method embodied therein. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a hardware and software program such as for example, but not limited to, Apache, PHP, Elgg. PHP social networking framework, Mysql, HTML5, JQuery, JavaScript, cascading style sheets (CSS), or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the invention.

What is claimed is:

1. A method for automatically creating a companionship between a user and at least one item source using a server, the method comprising:
rendering a virtual environment selected by a user, wherein said virtual environment is configured to simulate a virtual appearance of at least one real-world entity;
receiving at least one item selected by said user from a plurality of items, wherein said at least one item is associated with said at least one item source;
displaying said at least one selected item in said virtual environment, wherein said at least one selected item is integrated in said virtual environment; and
automatically creating a companionship between said user and said at least one item source based on said at least one selected item.

2. The method of claim 1, wherein automatically creating said companionship between said user and said at least one item source based on said at least one selected item comprises automatically establishing a friend connection between said user and said at least one item source associated with said at least one selected item, wherein said companionship is a 2-way companionship.

3. The method of claim 1, wherein said virtual environment is a drawing canvas.

4. The method of claim 1, wherein said virtual environment is hosted by said server.

5. The method of claim 1, wherein said plurality of items are customized based on at least one of said user location, said user interest, at least one item source, and at least one item.

6. The method of claim 1, wherein said method further comprises:
facilitating a real-time communication session between said user and said at least one item source based on said companionship, wherein said real-time communication session comprises an online chat session; and
performing at least one action based on said communication.

7. The method of claim 6, wherein said action comprises performing at least one of a transaction purchase said at least one item, an enquiry about said at least one transaction, and a purchase transaction to sponsor said at least one item.

8. The method of claim 1, wherein said method further comprises:
facilitating a non-real-time communication session between said user and said at least one item source based on said companionship, wherein said non-real-time communication session comprises at least one of an offline chat session, and an offline email session; and
performing at least one action based on said communication.

9. A server for automatically creating a companionship between a user and at least one item source, the server is configured to:
render a virtual environment selected by a user, wherein said virtual environment is configured to simulate a virtual appearance of at least one real- world entity;
receive at least one item selected by said user from a plurality of items, wherein said at least one item is associated with said at least one item source;
display said at least one selected item in said virtual environment, wherein said at least one selected item is integrated in said virtual environment; and
automatically create a companionship between said user and said at least one item source based on said at least one selected item.

10. The server of claim 9, wherein automatically creating said companionship between said user and said at least one item source based on said at least one selected item comprises automatically establishing a friend connection between said user and said at least one item source associated with said at least one selected item, wherein said companionship is a 2-way companionship.

11. The server of claim 9, wherein said virtual environment is a drawing canvas.

12. The server of claim 9, wherein said plurality of items are customized based on at least one of said user location, said user interest, at least one item source, and at least one item.

13. The server of claim 9, wherein said server is further configured to:
facilitate a real-time communication session between said user and said at least one item source based on said companionship, wherein said real-time communication session comprises an online chat session; and
perform at least one action based on said communication.

14. The server of claim 13, wherein said action comprises perform at least one of a transaction purchase said at least one item, an enquiry about said at least one transaction, and a purchase transaction to sponsor said at least one item.

15. The server of claim 9, wherein said server is further configured to:
facilitate a non-real-time communication session between said user and said at least one item source based on said companionship, wherein said non- real-time communication session comprises at least one of an offline chat session, and an offline email session; and
perform at least one action based on said communication.

16. A computer program product comprising a computer executable program code recorded on a computer readable non-transitory storage medium, said computer executable program code when executed, causing the actions including:
rendering a virtual environment selected by a user, wherein said virtual environment is a drawing canvas configured to simulate a virtual appearance of at least one real-world entity;
receiving at least one item selected by said user from a plurality of items, wherein said at least one item is associated with said at least one item source;
displaying said at least one selected item in said virtual environment, wherein said at least one selected item is integrated in said virtual environment; and
automatically creating a companionship between said user and said at least one item source based on said at least one selected item.

17. The computer program product of claim 16, wherein automatically creating said companionship between said user and said at least one item source based on said at least one selected item comprises automatically establishing a friend connection between said user and said at least one item source associated with said at least one selected item, wherein said companionship is a 2-way companionship.

18. The computer program product of claim 16, wherein said plurality of items are customized based on at least one of said user location, said user interest, at least one item source, and at least one item.

19. The computer program product of claim 16, wherein said computer executable program code when executed further causing the actions including:
facilitating a real-time communication session between said user and said at least one item source based on said companionship, wherein said real-time communication session comprises an online chat session; and
performing at least one action based on said communication, wherein said action comprises performing at least one of a transaction purchase said at least one item, an enquiry about said at least one transaction, and a purchase transaction to sponsor said at least one item.

20. The computer program product of claim 16, wherein said computer executable program code when executed further causing the actions including:
facilitating a non-real-time communication session between said user and said at least one item source based on said companionship, wherein said non-real-time communication session comprises at least one of an offline chat session, and an offline email session; and
performing at least one action based on said communication.
